(19) United States
(12) Patent Application Publication
(10) Pub. No.: US 2004/0265469 A1
(43) Pub. Date: Dec. 30, 2004

(54) Cereal cone

(76) Inventors: Sylke Neidlinger, Montagny-pres-Yverdon (CH); Osvaldo Geromini, Orbe (CH); Ernst Heck, Vufflens-la-Ville (CH)

Correspondence Address: WINSTON & STRAWN, PATENT DEPARTMENT, 1400 L STREET, N.W., WASHINGTON, DC, 20005-3502, US

(21) Appl. No.: 10/875,298

(22) Filed: Jun. 25, 2004

Related U.S. Application Data
(63) Continuation of application No. PCT/EP02/14879, filed on Dec. 23, 2002.

(30) Foreign Application Priority Data
Dec. 30, 2001 (EP) 01205185.0

(51) Int. Cl. A23L 1/168

(52) U.S. Cl. 426/618

(57) ABSTRACT

A method of making a cereal cone composition having a texture and physical aspect which are especially attractive by producing at least one strip of expanded cereal by extrusion-cooking, sheeting the strip between rolls, cutting the sheet into blanks and forming the blanks into a cone shape. The resulting cone represents another embodiment of the invention, as does its method of making.

### CROSS-REFERENCE TO RELATED APPLICATIONS

This application is a continuation of International application PCT/EP02/14879 filed Dec. 23, 2002, the entire content of which is expressly incorporated herein by reference thereto.

### BACKGROUND

The present invention relates to a cereal cone and to a process for manufacturing it.

Traditionally, products such as pastry cups, ice cream cones or the like are made by baking a batter into a wafer or waffle blank or strip and forming the blank or strip into a cone shape.

Typically, such products are generally known. For example, U.S. Pat. No. 4,761,293 (Herting) discloses a method and apparatus for making baked cones or cornets of baked wafer elements, especially coiled cones adapted to receive ice-cream or other comestible products.

U.S. Pat. No. 3,958,912 (Griner et al.) discloses a method for directly making pastry cups, ice cream cones or the like by baking a batter in split molds carried by mold bars, the molds cooperating with removable cores carried by core bars selectively latched to the mold bars.

Despite these disclosures, there remains a need for improved cereal cones for ice cream and other frozen confection novelties, and in particular with regard to its texture and organoleptic properties. Such improved products are now provided by the present invention.

### SUMMARY OF THE INVENTION

The present invention now provides a cereal cone having a texture which notably and advantageously differs from the texture of traditional wafer or waffle cones.

The invention also provides a process for manufacturing such a cereal cone wherein the texture notably and advantageously differs from the texture of traditional wafer or waffle cones.

To this end, the present cereal cone has a porous texture and comprises, in percent by weight, from 60 to 85% of cereal flour, from 2 to 10% of starch, from 8 to 20% of sugar, from 5 to 12% of milk powder, from 2 to 10% of oil or fat and from 1 to 5% of residual water. The cereal cone is obtainable by extrusion cooking of the mixture to form an expanded strip, followed by arranging the strip in a conical configuration to form the cone.

The present process for manufacturing a cereal cone includes the steps of producing at least one strip of expanded cereal by extrusion-cooking, sheeting the strip between rolls, cutting the sheet into blanks and forming the blanks into a cone shape. Preferably, this cereal strip has the previously mentioned composition.

The invention also relates to a method of making a cereal cone composition having a texture and physical aspect which are especially attractive by producing at least one strip of expanded cereal by extrusion-cooking, sheeting the strip between rolls, cutting the sheet into blanks and forming the blanks into a cone shape.

### DETAILED DESCRIPTION OF THE INVENTION

It has surprisingly been found that it is possible to now provide cones having a texture which notably and advantageously differs from the texture of traditional wafer or waffle cones. As a matter of fact it is possible in this way to provide cones having a porous, crispy or even a cracking texture recalling a biscuit texture wherein the texture stays crisp and crunchy after being filled with a frozen confection and during consumption.

Moreover it has surprisingly been found that it is possible in this way to provide cones made of a larger range of ingredients than traditional wafer or waffle cones, and it is possible in this way to provide cones having not only different textures but also different aspects. It is also possible to provide multicolored cones in this manner. Thus, more flexibility has been found in the choice of texture, in the choice of ingredients, and in the choice of surface definition (especially as physical aspect, relief and color is concerned).

The present invention therefore also involves a method of making the composition, the texture and the physical aspect of a cereal cone especially attractive by producing at least one strip of expanded cereal by extrusion-cooking, sheeting the strip between rolls, cutting the sheet into blanks and forming the blanks into a cone shape. As noted, the present cereal cone made by this method thus comprises, in percent by weight, from 60 to 85% of cereal flour, from 2 to 10% of starch, from 8 to 20% of sugar, from 5 to 12% of milk powder, from 2 to 10% of oil or fat and from 1 to 5% of residual water. The present cereal cone may further comprise up to 2% of honey, up to 2% each of optional ingredients such as glycose syrup, flavoring agents or coloring agents.

The cereal flour advantageously is wheat, barley, rice or corn.

The starch may be a native starch from wheat, barley, rice, tapioca, potato or corn, and especially waxy corn.

The sugar may be sucrose, dextrose or fructose.

The milk powder may be a powdered whole milk, a powdered skimmed milk or a powdered partly skimmed milk.

The fat may be milk fat or vegetable fat such as butter oil or vegetable oil or fat. This component acts as a lubricating agent in the extrusion-cooking process that is used to prepare the strip.

The present cereal cone may be eaten or used as such, or after having been coated (especially after having been internally coated with a chocolate coating), a preferred use being a use as ice cream cone.

The present process for manufacturing a cereal cone thus includes producing at least one strip of expanded cereal by extrusion-cooking, sheeting the strip between rolls, cutting the sheet into blanks and forming the blanks into a cone shape.

Producing at least one strip of expanded cereal by extrusion-cooking may be carried out by firstly preparing a mixture comprising, in parts by weight, from 60 to 85 parts of cereal flour, from 2 to 10 parts of starch, from 8 to 20 parts of sugar, from 5 to 12 parts of milk powder, from 2 to 10 parts of oil or fat, and added water up to a water content of from 11 to 19% by weight of the mixture, such a water content being adequate for obtaining a correct expansion after extrusion of the cooked mixture.

The mixture may further comprise up to 2 parts of honey, up to 2 parts of each of glycose syrup, flavoring agents or coloring agents.

The mixture may be prepared by first mixing together powdery components to obtain a dry mix and then mixing together the dry mix and liquid or fluid components.

This mixing step may be carried out in a first mixing section of a traditional food extruder, especially a twin screw extruder, for example.

Cooking the mixture may then be carried out at 110 to 180° C. under 10 to 14 MPa for 5 to 50 s in subsequent sections of the extruder where the mixture is heated, compressed and sheared so that it forms a cooked thermoplastic mass. The thermoplastic mass may be extruded by having it pushed by the extruder screw or twin screw through the openings of a die provided for at an end of the extruder.

The die may have one or more slot shaped extrusion openings having a length about 10 to 50 times its width, and a width of from about 0.5 to 2.5 mm, for example. In front of the extrusion slot the die may have an expansion control slot of larger cross-section than the cross-section of the extrusion slot (especially of a larger width of from about 1 to 8 mm), for expanding the strip of thermoplastic mass to its final form. An adequate die of this kind is disclosed in U.S. Pat. No. 4,772,197, the content of which is expressly incorporated herein to the extent necessary to understand the invention.

The thermoplastic mass may thus be expanded by extruding it through the die into an open space at ambient temperature and at atmospheric pressure. Water is lost in form of steam escaping the thermoplastic mass during expansion so that the strip thus obtained has a porous texture and may have a water content of from 4 to 8%.

The step of sheeting the extrusion-cooked and expanded strip may be carried out while the strip is still hot (namely still in a thermoplastic state), between roll surfaces that have a relief corresponding to a relief which one wants to impart to or to press into the surface of the strip. Such a relief may comprise a repeating motif in form of individual lines or of a network of lines which intersect, as is usually seen in conventional cake or cereal cones.

The step of cutting may be carried out by a cutting machine capable of continuously cutting the sheet into blanks having the shape of triangles (or trapezium) which follow each other side by side along the strip (the base of a triangle being adjacent the apex of the following triangle) so that only little waste has to be recycled.

The blanks, still in a thermoplastic state, may then be formed into cones either by coiling or by pressing in a mold.

The cones may finally be dried to a residual water content of from 1 to 5%, preferably from 1 to 3%, such as on a belt drier with hot air.

The finished cones generally have a weight of from 1 to 20 g and a height of from 2 to 15 cm.

The cereal cone thus obtained, or even if possibly coated (especially chocolate coated internally), may be conditioned in a packing providing for its protection against humidity. This is conveniently done using a packing made of a film with aluminum foil.

### EXAMPLE

The following example is given as illustration of an embodiment of the cereal cone and an embodiment of the process for manufacturing it according to the present invention. The parts and percentages are by weight.

For manufacturing a cereal cone, a mixture was prepared which had the following composition, (in parts, except added water):

| | |
|---|---|
| wheat flour | 78 |
| starch | 4 |
| sugar | 10 |
| milk powder (26% fat) | 8 |
| oil | 7 |
| honey | 1 |
| glucose syrup | 1 |
| vanillin | 0.05 |
| added water, up to a water | 12% |
| content of | |

For preparing the mixture, the powders were first mixed together to obtain a dry mix. The dry mix, oil and added water were then mixed together in the extruder. The mixture obtained in this way was extrusion-cooked with the aid of a BC-72 type CLEXTRAL twin screw extruder having a screw diameter of 88 mm and a total processing length of 900 mm.

Extrusion-cooking was carried out at 135° C. under 14 MPa for 30 s, the two intermeshing screws rotating at 190 rpm (preferred range 150 to 300 rpm). The cooked thermoplastic mass obtained in this way was extruded through a die having one slot shaped outlet opening and one expansion control slot in front of it.

The thermoplastic mass was extruded into ambient air and the expanded strip thus obtained was immediately sheeted (while still in a thermoplastic state) between rolls the surface of which had a relief in form of parallel lines spaced about 2 mm from each other.

The sheet thus obtained was cut into blanks having a triangular shape.

The triangular flat blanks thus obtained (still in a thermoplastic state) were coiled or rolled into cones.

The cones were then dried to a residual water content of about 2-3%.

The finished cones each had a weight of about 10 g and a height of about 10 cm.

The cones had an attractive aspect and a porous, crispy texture which stay crisp. This texture could be said even to be cracking and recalling a biscuit texture.

What is claimed is:

1. A cereal cone having a porous texture and comprising, in percent by weight, a mixture of from 60 to 85% of cereal flour, from 2 to 10% of starch, from 8 to 20% of sugar, from 5 to 12% of milk powder, from 2 to 10% of oil or fat and from 1 to 5% of residual water.

2. The cereal cone of claim 1, further comprising honey in an amount of up to 2% and glycose syrup in an amount of up to 2%.

3. The cereal cone of claim 1, having from 1 to 3% of residual water.

4. The cereal cone of claim 1 obtainable by extrusion cooking of the mixture to form an expanded strip, followed by arranging the strip to a conical configuration to form the cone.

5. A process for manufacturing a cereal cone, which comprises producing at least one strip of an expanded cereal by extrusion-cooking the mixture of claim 1, sheeting the strip between rolls, cutting the sheet into blanks and forming the blanks into a cone shape.

6. A process for manufacturing a cereal cone, which comprises producing at least one strip of an expanded cereal by extrusion-cooking, sheeting the strip between rolls, cutting the sheet into blanks and forming the blanks into a cone shape.

7. The process of claim 5, wherein the at least one strip of expanded cereal is produced by firstly preparing a mixture comprising, in parts by weight, from 60 to 85 parts of cereal flour, from 2 to 10 parts of starch, from 8 to 20 parts of sugar, from 5 to 12 parts of milk powder, from 2 to 10 parts of oil or fat, and added water up to a water content of from 11 to 19%, cooking the mixture at 110 to 180° C. under 10 to 14 MPa for 5 to 50 s in an extruder to form a cooked thermoplastic mass, and extruding the cooked thermoplastic mass by pushing it with an extruder screw or twin screw through at least one slot shaped extrusion opening of an extruder die.

8. The process of claim 5, wherein the sheet is cut into blanks having the shape of triangles or trapeziums.

9. The process of claim 5, wherein the blanks are formed into cones either by coiling or by pressing in a mold while the blanks are still in a thermoplastic state.

10. The process of claim 5, which further comprises drying the cones to a residual water content of from 1 to 3%.

11. The process of claim 5, which further comprises imparting a relief in a surface of the expanded strip, the relief comprising a repeating motif in form of individual lines or a network of lines which intersect.

12. A method of making a cereal cone composition having a texture and physical aspect which are especially attractive by producing at least one strip of expanded cereal by extrusion-cooking, sheeting the strip between rolls, cutting the sheet into blanks and forming the blanks into a cone shape.

13. The method of claim 12, which further comprises imparting a relief in a surface of the expanded strip, the relief comprising a repeating motif in form of individual lines or a network of lines which intersect.

14. A method of making a cereal cone composition having a texture and physical aspect which are especially attractive by producing at least one strip of an expanded cereal by extrusion-cooking the mixture of claim 1, sheeting the strip between rolls, cutting the sheet into blanks and forming the blanks into a cone shape.

15. The method of claim 14, which further comprises imparting a relief in a surface of the expanded strip, the relief comprising a repeating motif in form of individual lines or a network of lines which intersect.
